(19) United States
(12) Patent Application Publication
(10) Pub. No.: US 2025/0264929 A1
(43) Pub. Date: Aug. 21, 2025

(54) Operating Performance Point Aware In-Rush Current Surge Preclusion of Memory Systems of Integrated Circuitry

(71) Applicant: Google LLC, Mountain View, CA (US)

(72) Inventor: Janardan Prasad, Bangalore (IN)

(73) Assignee: Google LLC, Mountain View, CA (US)

(21) Appl. No.: 19/200,941

(22) Filed: May 7, 2025

Related U.S. Application Data
(60) Provisional application No. 63/800,602, filed on May 6, 2025.

(51) Int. Cl. G06F 1/3234; G06F 1/3206

(52) U.S. Cl. CPC G06F 1/3275; G06F 1/3206

(57) ABSTRACT

This document describes a technology for precluding or avoiding in-rush current surges in memory wake-up sequences in integrated circuitry. This technology includes a power management unit coupled with wake-up sources and static random-access memory (SRAM) groups in a memory subsystem. This technology stores multiple sets of Operating Performance Point (OPP)-dependent SRAM activation sequences in a dataset library. This technology receives a wake-up notification and obtains a present OPP of the integrated circuitry. This technology selects a dataset with an associated OPP that matches the present OPP. This disclosed technology activates SRAM groups in stages according to the activation sequence of the matched dataset, with each stage holding for a limited wait time before activating the next stage. With an awareness of the present OPP, this technology is capable of precluding the in-rush current surge that occurs during the wake-up of memory.

### CROSS-REFERENCE TO RELATED APPLICATION

This application claims the benefit of U.S. Provisional Patent Application Ser. No. 63/800,602 filed on May 6, 2025, the disclosure of which is incorporated by reference herein in its entirety.

### SUMMARY

This document describes a technology for precluding or avoiding in-rush current surges in memory wake-up sequences in integrated circuitry. This technology includes a power management unit coupled with wake-up sources and static random-access memory (SRAM) groups in a memory subsystem. This technology stores multiple sets of Operating Performance Point (OPP)-dependent SRAM activation sequences in a dataset library. This technology receives a wake-up notification and obtains a present OPP of the integrated circuitry. This technology selects a dataset with an associated OPP that matches the present OPP. This disclosed technology activates SRAM groups in stages according to the activation sequence of the matched dataset, with each stage holding for a limited wait time before activating the next stage. With an awareness of the present OPP, this technology is capable of precluding the in-rush current surge that occurs during the wake-up of memory.

This summary is provided to introduce simplified concepts for a technology for managing in-rush current during memory wake-up sequences in integrated circuitry, which is further described below in the Detailed Description and Drawings. This summary is not intended to identify essential features of the claimed subject matter, nor is it intended for use in determining the scope of the claimed subject matter.

### BRIEF DESCRIPTION OF THE DRAWINGS

The details of one or more aspects for precluding in-rush current surges, such as during static random-access memory (SRAM) memory wake-up sequences in integrated circuitry, are described in this document with reference to the following drawings. The same numbers are used throughout the drawings to reference like features and components:

FIG. 1 illustrates an example operating environment 100 in which techniques for precluding in-rush current surges may be implemented;

FIG. 2 illustrates a simplified computer architecture of an example integrated circuitry 200, in which techniques for precluding in-rush current surges may be implemented;

FIG. 3 illustrates an example scenario 300 of an example operation for precluding in-rush current surges during SRAM wake-up sequences in accordance with the technology described herein; and

FIG. 4 illustrates an example method 400 for in-rush current surge preclusion on SRAM memory in accordance with one or more implementations described herein.

### DETAILED DESCRIPTION

### Overview

A technology is described herein for optimizing a wake-up procedure of a static random-access memory (SRAM) memory subsystem of integrated circuitry. The technology described herein wakes up the SRAM memory activation in stages to avoid or preclude the potentially damaging effects of in-rush current surges. The technology described herein addresses a challenge of modern integrated circuitry: safely awakening the SRAM memory subsystem while maximizing performance.

Typically, working memory is volatile and comes in two main flavors: static and dynamic. Volatile memory loses stored information when power is disconnected. Both flavors of memory store data temporarily while an integrated circuitry is in operation. However, they differ in their data retention approach. DRAM (dynamic random-access memory) requires regular refresh cycles to maintain stored data. DRAM memory cells consist of one transistor and one capacitor. The capacitor leaks electrical charge gradually, thus, refresh operations must occur every few milliseconds. In contrast, each memory cell of an SRAM (static random-access memory) utilizes multiple transistors to maintain the data stored within without requiring refresh cycles.

SRAM is often used in power-restricted (e.g., battery-powered) circuitry that employs a “sleep” mode. In this mode, the SRAM enters a low-power state while maintaining data. In sleep mode, SRAM maintains a minimal power connection to the memory cells, providing sufficient voltage to retain stored information. Current consumption drops significantly during sleep. The SRAM remains powered but inactive. This differs from complete power-off conditions.

Wake-up transitions the SRAM from sleep mode to active operation. Wake-up uses less energy than the initial power-up of the SRAM. The power-up process involves applying voltage to completely unpowered circuits. In contrast, the wake-up process increases the voltage or clock signals to already powered SRAM. The wake-up transition creates smaller current surges compared to power-up events. Battery life extends through efficient sleep-wake cycles. The reduced energy requirements benefit portable electronic devices.

Because each memory cell of an SRAM utilizes more electronic elements than that of a DRAM, the SRAM memory cell consumes more power during normal operation. The power consumption issues extend to wake-up conditions where in-rush current occurs. An in-rush current surge is the large instantaneous current drawn by an electrical component (e.g., memory) when first powered on. The in-rush current surge may exceed the normal operating current. The surge creates a momentary spike 5-10 times higher than normal operating levels with a time period that typically spans microseconds to milliseconds.

Excess current generates heat that can, over time, irreversibly damage silicon structures. Current surges also result in voltage drops on power rails. Such voltage fluctuations destroy gate oxides in delicate transistors. Metal traces may become overheated and fail in such conditions. Failure may not occur immediately, even if it is likely; however, continuous thermal stress degrades interconnects and solder joints. Typically, designers include additional components to safeguard against in-rush current surges, but at the expense of increased system cost, complexity, and board space usage.

The technology described herein provides a wake-up sequence of the SRAM memory of an integrated circuitry that avoids potentially harmful in-rush current surges by activating SRAM groups in timed stages. To achieve an optimal balance between safety and speed, the technology selects an activation sequence of SRAM groups that best matches the particular present operating condition of the integrated circuitry. With this approach, the SRAM becomes fully operational at the optimal clock frequency while minimizing the risk of hardware damage. The timed staging minimizes wake-up latency while ensuring current levels remain within safe parameters.

### Operating Environment

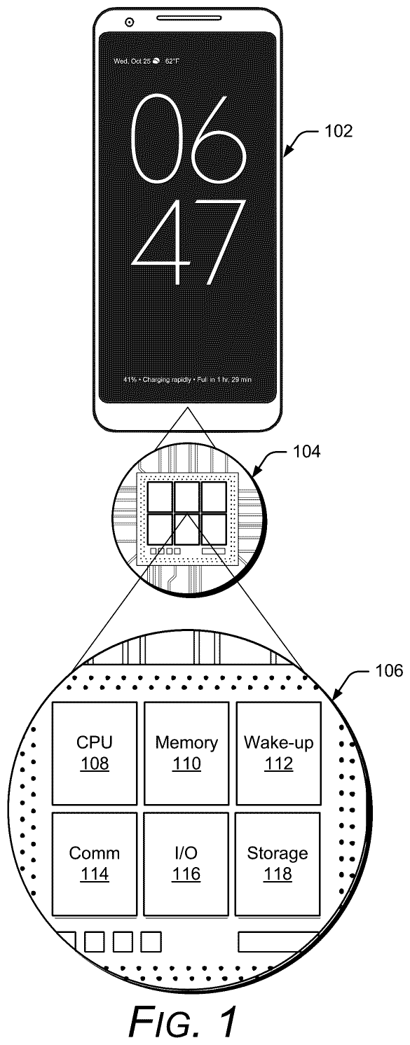

FIG. 1 illustrates an example operating environment 100 in which techniques for optimizing a wake-up procedure of a static random-access memory (SRAM) memory subsystem may be implemented. The example operating environment 100 includes user equipment 102 (e.g., smartphone, mobile device, wearable, tablet, or computing device). The user equipment includes the integrated circuitry (IC) 104, which includes integrated-circuitry components 106.

The integrated circuitry 104 includes, for example, electronic components fabricated on a single piece of semiconductor material. This circuitry contains multiple electronic elements combined into a unified structure. Examples of implementations of the integrated circuitry 104 include, but are not limited to, System on a Chip (SoC), Microcontroller Units (MCUs), Field Programmable Gate Arrays (FPGAs), Application Specific Integrated Circuits (ASICs), Graphics Processing Units (GPUs), Digital Processing Units (DPUs), Memory Management Units (MMUs), or a combination thereof. As shown, the integrated circuitry 104 is a SoC, which incorporates all necessary electronic components of a computer or other electronic system into a single microchip.

As shown, the integrated-circuitry components 106 include at least one central processing unit (CPU) 108, memory 110, a wake-up system 112, a communication (“comm”) interface 114, an input/output (I/O) system 116, a storage system 118, and/or other components not shown in FIG. 1.

The CPU 108 includes one or more physical devices configured to execute instructions. For example, the CPU 108 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The CPU 108 may include one or more processors configured to execute software instructions. Additionally or alternatively, the CPU 108 may include one or more hardware or firmware logic machines configured to execute hardware or firmware instructions. Processors of the CPU 108 may be single-core or multi-core, and the instructions executed thereon may be configured for sequential, parallel, and/or distributed processing. Individual components of the CPU 108 optionally may be distributed among two or more separate devices, which may be remotely located and/or configured for coordinated processing. Aspects of the CPU 108 may be virtualized and executed by remotely accessible, networked computing devices configured in a cloud-computing configuration.

The memory 110 is a computer-readable medium that the CPU 108 uses when operating. Thus, the memory 110 may be called the working or runtime memory. Applications, data, and/or an operating system embodied as computer-readable instructions on the memory 110 can be executed by the CPU 108. The memory 110 may include, for example, random access memory (RAM), cache memory, and read-only memory (ROM). More particularly, the memory 110 includes SRAM subsystem that can be activated (“awoken”) or deactivated (“asleep”) to conserve power on the integrated circuitry 104.

The wake-up system 112 is a control mechanism for activating deactivated computing components and systems of the integrated circuitry 104, such as the integrated-circuitry components 106. This may be described as the wake-up system 112 awakening sleeping components and systems. The wake-up system 112 monitors conditions of the integrated circuitry 104 to determine when to reactivate sleeping systems and components. For instance, the wake-up system 112 may generate a “wake-up” signal to activate the SRAM portions within memory 110.

Wake-up system 112 contains sensory or measurement components that detect various trigger events. Such events may include, for example, external interrupts, timer expirations, or signal patterns. Also, the wake-up system 112 may evaluate inputs against predetermined threshold values to make activation decisions.

Upon meeting activation criteria, the wake-up system 112 generates appropriate control “wake-up” signals. These signals travel to reach target systems and components. Subsequently, the control signals initiate wake-up sequences in previously deactivated SRAM regions of memory 110.

Wake-up system 112 may signal an activation of SRAM when processing requirements increase or when incoming data requires immediate handling. Also, memory activation may occur when cached information needs to be refreshed from persistent storage. Through these mechanisms, the wake-up system 112 facilitates efficient power management while maintaining functionality.

The communication (“comm”) interface 114 may be configured to communicatively couple user equipment 102 with one or more other computing devices. The comm interface 114 may include wired and/or wireless communication devices compatible with one or more different communication protocols. As non-limiting examples, the communication interface 114 may be configured for communication via a wireless telephone network, or a wired or wireless local- or wide-area network. In some embodiments, the communication interface 114 may allow user equipment 102 to send and/or receive messages to and/or from other devices via a network such as the Internet.

The input/output (I/O) system 116 provides mechanisms for the user equipment 102 to receive input and/or send output. The I/O system 116 may include a display subsystem (not shown), which may be used to present a visual representation of data held by a memory (e.g., memory 110) or by the storage system 118. This visual representation may take the form of a graphical user interface (GUI). As the herein described methods and processes change the data held by a memory (e.g., memory 110) or by the storage system 118, and thus transform its state, the state of display subsystem may likewise be transformed to visually represent changes in the underlying data. Display subsystem may include one or more display devices utilizing virtually any type of technology.

The I/O system 118 may include an input subsystem (not shown), which may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

The storage system 118 is a computer-readable medium that stores data for use later. The storage system 118 includes one or more physical devices configured to hold instructions executable by the CPU 108 to implement the methods and processes described herein. When such methods and processes are implemented, the state of the storage system 118 may be transformed—e.g., to hold different data.

The storage system 118 may include removable and/or built-in devices. The storage system 118 may include, for example, optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The storage system 118 may include volatile, nonvolatile, dynamic, static, read/write, read-only, random-access, sequential-access, location-addressable, file-addressable, and/or content-addressable devices. In some instances, the storage system 118 may be implemented by a so-called cloud storage service.

It will be appreciated that the storage system 118 includes one or more physical devices. However, aspects of the instructions described herein alternatively may be propagated by a communication medium (e.g., an electromagnetic signal, an optical signal, etc.) that is not held by a physical device for a finite duration

### Simplified Computer Architecture of an Example Integrated Circuitry

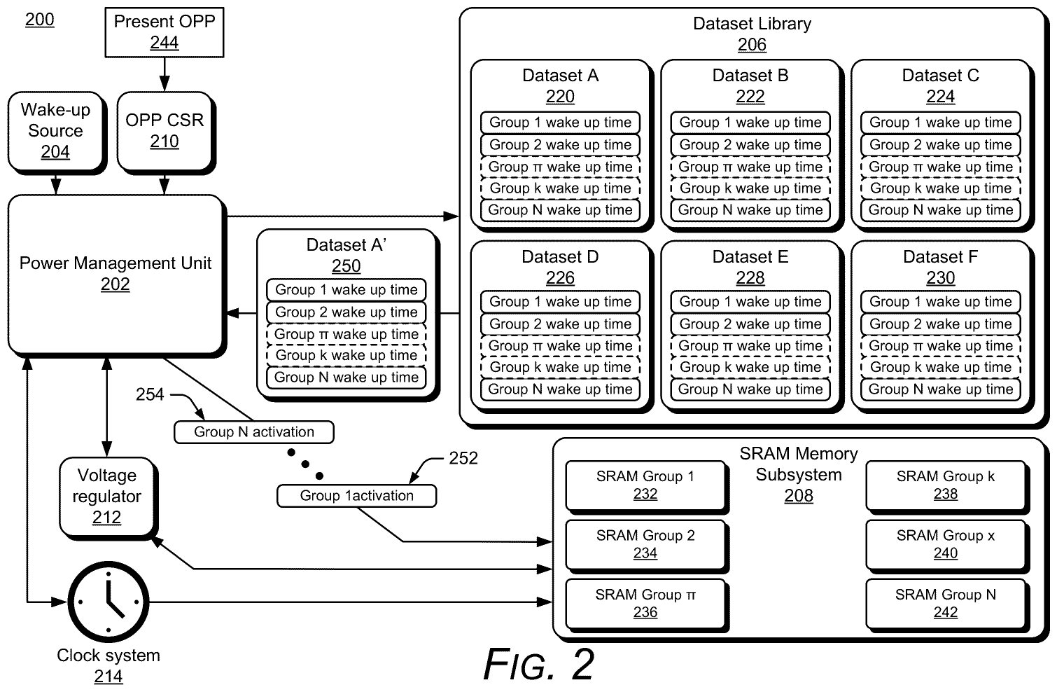

FIG. 2 illustrates a simplified computer architecture of an example integrated circuitry 200, in which techniques for optimizing the wake-up procedure of an SRAM memory subsystem may be implemented. The example apparatus 200 (such as integrated circuitry 104) includes a power management unit (PMU) 202, wake-up source 204, a dataset library 206, an SRAM memory subsystem 208, an operating performance point (OPP) control and status registers (CSRs) 210, a voltage regulator 212, and a clock system 214.

The power management unit 202 controls power distribution across the integrated circuitry 200. That is, the power management unit 202 regulates power distribution from the power source (e.g., batteries) and use of such power. Often, a main goal of the power management unit 202 is to conserve power usage. To that end, power management unit 202 may adjust the voltage based on processing needs while switching between active, idle, and sleep states. For efficiency, the power management unit 202 may scale the voltage and adjust the clock frequencies. Furthermore, the power management unit 202 places inactive components in low-power states or powers off unused subsystems completely. Throughout operation, the power management unit 202 may monitor temperature, prevent overcharging, and regulate discharge rates. In cooperation with the operating system (OS), the power management unit 202 extends battery life while maintaining consistent performance.

The wake-up source 204 is a hardware or software component that generates a wake-up notification (e.g., a signal) indicating that a wake-up triggering event or condition has occurred. When triggered, the wake-up source 204 sends a notification to the power management unit 202, which, in response, awakens one or more sleeping components or subsystems of the integrated circuitry 200. Thus, the awakened components or subsystems resume normal operational functionality. The wake-up source 204 may include one or more such sources.

Examples of events or conditions that may trigger a wake-up notification include user input (e.g., physical button presses, touchscreen interaction), timers/alarms, peripheral activity (e.g., memory card insertion, physical device connection), communications signals (e.g., incoming wireless packets, Bluetooth™ connections, or cellular network activity), sensors (e.g., motion detection, temperature threshold, light level change), external interrupts (e.g., voltage change on pins configured to detect such change), power-state change (e.g., battery level thresholds or external power connection), software commands (e.g., internal software flags or conditions that require calculations), inter-processor communication (e.g., messages from co-processors or other controllers), or the like.

The dataset library 206 is a computer-readable medium for storing datasets that are utilized by the power management unit 202 to implement the technology described herein. The dataset library 206 is a non-volatile memory (NVM) that maintains data without power, such as a ROM, PROM (Programmable Read-Only Memory), EPROM (Erasable Programmable Read-Only Memory), EEPROM (Electrically Erasable Programmable Read-Only Memory), Flash memory, FRAM/FeRAM (Ferroelectric Random-Access Memory), MRAM (Magnetoresistive Random-Access Memory), PCM (Phase-Change Memory), ReRAM/RRAM (Resistive Random-Access Memory), nvSRAM (Non-Volatile Static Random-Access Memory), OTP (One-Time Programmable) memory, and MTP (Multi-Time Programmable) memory.

The dataset library 206 is configured to store multiple datasets. As depicted, the dataset library 206 includes dataset A 220, dataset B 222, dataset C 224, dataset D 226, dataset E 228, and dataset F 230. Each dataset includes a listing of an operating performance point (OPP)-dependent SRAM activation sequence and an associated defined OPP. The OPP-dependent SRAM activation sequence specifies the order and timing of activation (e.g., waking up) of groupings of SRAM of the SRAM memory subsystem 208. In a power management context, Operating Performance Points (OPPs) are specified operating states on an integrated circuitry, such as the integrated circuitry 200. The specified OPP of the integrated circuitry 200 are discrete voltage-frequency pairs where the integrated circuitry operates reliably.

The SRAM memory subsystem 208 may be part of the memory 110. The SRAM memory subsystem 208 includes the SRAM, which serves as the working memory used by the CPU (e.g., CPU 108) within the integrated circuitry 200. Under the direction of the power management unit 202, the SRAM of the SRAM memory subsystem 208 can be selectively deactivated (e.g., put to sleep) or activated (e.g., awakened).

As shown in FIG. 2, the SRAM memory subsystem 208 includes multiple groupings of SRAMs: SRAM group 1 232, SRAM group 2 234, SRAM group π 236, SRAM group K 268, SRAM group π 240, and SRAM group N 242. Each group includes SRAM that can be reliably activated (e.g., awakened) together safely (e.g., without ill effects of in-rush current surge) and quickly. In some implementations, the order of activation of the SRAM groups remains unchanged, regardless of the integrated circuit's operating conditions. In other implementations, the order may change.

Several factors may contribute to the grouping of SRAM. For example, SRAM may be grouped so that each group has similar current draw characteristics during wake-up. With this approach, each SRAM would draw similar current during wake-up as the other groups. In another instance, SRAM may be grouped based on its physical proximity to other SRAMs. This approach aligns with how power distribution networks are typically arranged, with nearby memory blocks often sharing power delivery resources. In other instances, SRAM may be grouped together based on their functional role on the integrated circuitry 200. For example, SRAM may be grouped by cache levels, cache types (e.g., data or instruction), or criticality (e.g., critical vs. non-critical memory). In other instances, SRAM may be grouped based on sharing a power domain (e.g., common power rails or voltage regulator). In still other instances, SRAM may be grouped based upon usage pattern, size, or thermal considerations. Depending upon the implementations, the SRAM may be grouped based upon some combination thereof or some other similar consideration.

The OPP control and status registers (CSRs) 210 enables dynamic performance adjustments of the integrated circuitry 200. The OPP control and status registers 210 continuously monitor and detect the present OPP 244 of integrated circuitry. In this way, the OPP control and status register 210 is aware of the present OPP 244 of the integrated circuitry.

This detection involves internal sensors that measure actual voltage levels, current draw, and operating frequencies of the integrated circuitry 200. These specialized registers store and control voltage-frequency configurations for various operating states. Additionally, the registers capture thermal conditions, and processing loads across different circuit blocks. Subsequently, this real-time state information enables precise power management decisions.

With such circuitry, the power management systems intentionally set the voltage levels, current draw, and/or operating frequencies to be one of the predefined reliable OPP configurations. Thus, the OPP control and status registers 210 match the measured operating conditions to one of several potential OPPs. That matched OPP will be the present OPP 244.

The OPP control and status registers 210 work in tandem with the power management unit 202 to optimize operation of the integrated circuitry 200. The power management unit 202 analyzes the detected operating state 244 information from the OPP control and status registers 210. In this way, the power management unit is aware of the present OPP of the integrated circuitry 200.

The voltage regulator 212 maintains stable power delivery across the integrated circuitry 200. The voltage regulator 212 converts incoming power to precise voltage levels used by various components and subsystems of the integrated circuitry 200.

The clock system 214 generates and distributes timing signals throughout the integrated circuitry 200. It generates periodic signals to synchronize operations across different components. Additionally, the clock system 214 may enable dynamic frequency scaling to balance performance and power consumption. Furthermore, clock distribution networks ensure signals reach all parts of the chip with minimal skew. The clock system 214 determines both the operational speed and energy efficiency of the entire integrated circuit.

FIG. 2 shows that the power management unit 202 manages the optimization of the wake-up procedures to safely awaken the SRAM memory of the SRM memory subsystem 208 in stages to avoid the potentially damaging effects of in-rush current surges. The power management unit 202 receives a wake-up notification from a wake-up source 204. The power management unit 202 obtains the present OPP 244 of the integrated circuitry 200 from, for example, the OPP control and status registers 210.

The power management unit 202 searches the datasets of the dataset library 206 to find a dataset with an associated OPP that matches the present OPP 244. That is, the discrete voltage-frequency pairs of the associated OPP match the discrete voltage-frequency pairs of the present OPP 244. If there is no exact match, then identify two or more datasets with associated OPPs that closely match the present OPP 244. Of those, the dataset with an associated OPP that matches the present OPP 244 may be selected as the closest. A closest match may be, for example, the nearest match for voltage, frequency, or both voltage and frequency.

As shown in FIG. 2, dataset A′ 250 is extracted from dataset A 220 is in the dataset library 206. The dataset A′ 250 includes a table of entries that specify an activation sequence for SRAM groups of the SRAM memory subsystem 208. As shown, the order of activation is Group 1 (which is SRAM group 1 232), Group 2 (which is SRAM group 2 234), Group π (which is SRAM group π 236), Group 2 (which is SRAM group K 238), perhaps other groups, and Group N (which is SRAM group N 242). Along with each group entry, there is a specified wait time, which may be called a “wake-up time.” The wait time is the duration that the power management unit 202 waits before activating the next group in the sequence. Typically, wait time may be measured in clock cycles, such as two, ten, twenty, or more clock cycles.

The power management unit 202 activates each group of SRAMs in stages. As shown in FIG. 2, the power management unit 202 obtains the first entry of dataset A′ 250, which specifies the activation of Group 1 and its associated defined wait time. Thus, the power management unit 202 sends activation signal 252 to the SRAM memory subsystem 208 for SRAM Group 1 232 to be activated. While the SRAM Group 1 232 is awakening, the power management unit 202 waits for the defined wait time. This gives sufficient time for the in-rush current surge of the activation of the SRAM Group 1 232 to subside.

After the defined wait time for Group 1 has passed, the power management unit 202 repeats the same actions for the next entry of dataset A′ 250. This process repeats each entry of dataset A′ 250. Finally, the power management unit 202 obtains the last entry of dataset A′ 250, which specifies the activation of Group N and its associated defined wait time. Thus, the power management unit 202 sends activation signal 254 to the SRAM memory subsystem 208 for SRAM Group N 242 to be activated. While the SRAM Group N 242 is awakening, the power management unit 202 waits for the defined wait time. The wake-up stages are complete. All of the specified SRAM of the SRAM memory subsystem 208 are awake and potential damage from in-rush current surges was avoided.

### Example Operation

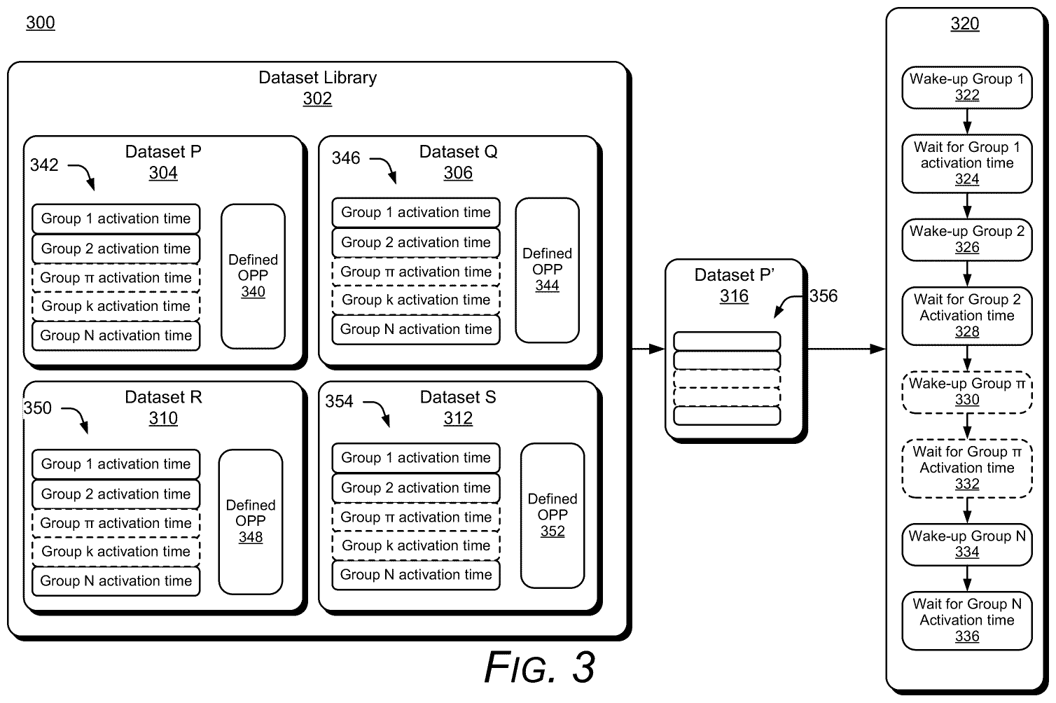

FIG. 3 illustrates an example scenario 300 of an example operation of in-rush current surge preclusion for SRAM memory systems (such as subsystem 208). The example scenario 300 includes a dataset library 302, matched dataset P′ 316, and in-rush current surge preclusion procedure 320.

The dataset library 302 is similar to the previously introduced dataset library 206. The dataset library 302 is configured to store multiple datasets. Each dataset includes a listing of an operating performance point (OPP)-dependent SRAM activation sequence and an associated defined OPP. The OPP-dependent SRAM activation sequence specifies the order and timing of activation (e.g., waking up) of groupings of SRAM (e.g., like that of the SRAM memory subsystem 208). OPPs are specific operating states on integrated circuitry, such as the integrated circuitry 200. Each OPP represents a specific voltage-frequency combination at which the integrated circuitry can operate reliably.

As depicted, the dataset library 302 includes dataset P 304, dataset Q 306, dataset R 310, and dataset S 312. Dataset P 304 includes a defined OPP 340 and a table 342 of entries that specify the activation order and timing of groupings of SRAMs, such as groups 232-242 of the integrated circuitry 200. The defined OPP 340 provides specific voltage-frequency combination of the integrated circuitry. Each entry in the table 342 specifies which SRAM group to activate and a defined wait or activation time. The defined wait time is the period during which the power management unit waits before activating the next SRAM group.

Dataset Q 306 has a similar arrangement of data with defined OPP 344 and a table 346 of entries that specify the activation order and timing of groupings of SRAMs, such as groups 232-242 of the integrated circuitry 200. Likewise, dataset R 310 has a similar arrangement with defined OPP 348 and a table 346 of SRAM group entries. Finally, dataset S 312 has a similar arrangement with defined OPP 352 and a table 354 of SRAM group entries. OPPs 340, 344, 348, and 352 differ from each other and match a specific voltage-frequency combination which are amongst the OPPs available to and already known by a power management system of integrated circuitry.

The matched dataset P′ 316 is an extracted copy of the table from dataset P 304. Thus, dataset P′ 36 includes a table 356 of entries that is a copy of table 342 of dataset P 304.

In-rush current surge preclusion procedure 320 is an example process that may be performed by a power management unit and/or OPP control and status registers (such as power management unit 202 and OPP control and status registers 210). After a wake-up of the SRAM is triggered, the matched dataset P′ 316 is provided to the in-rush current surge preclusion procedure 320.

At 322, the procedure 320 wakes up SRAM group 1 (such as SRAM group 1 232 of the integrated circuitry 200). At 324, the procedure waits for a defined “activation” time (e.g., wait time). This activation time is extracted from the entry in the table 356 regarding the SRAM group 1. Once the activation time period has passed, the procedure at 326 wakes up the group from the next entry in the Table 356. Thus, SRAM group 2 (such as SRAM group 2 234 of the integrated circuitry 200) is awakened. At 328, the procedure waits for a defined “activation” time (e.g., wait time) that was extracted from the group 2 entry in the table 356. At 330 and 332, the procedure repeats the activation and waits for all remaining SRAM group entries in the table 356. Finally, the procedure activates group N at 334 and waits for that group's activation time. Then the procedure 320 ends.

### Example In-Rush Current Surge Preclusion Method

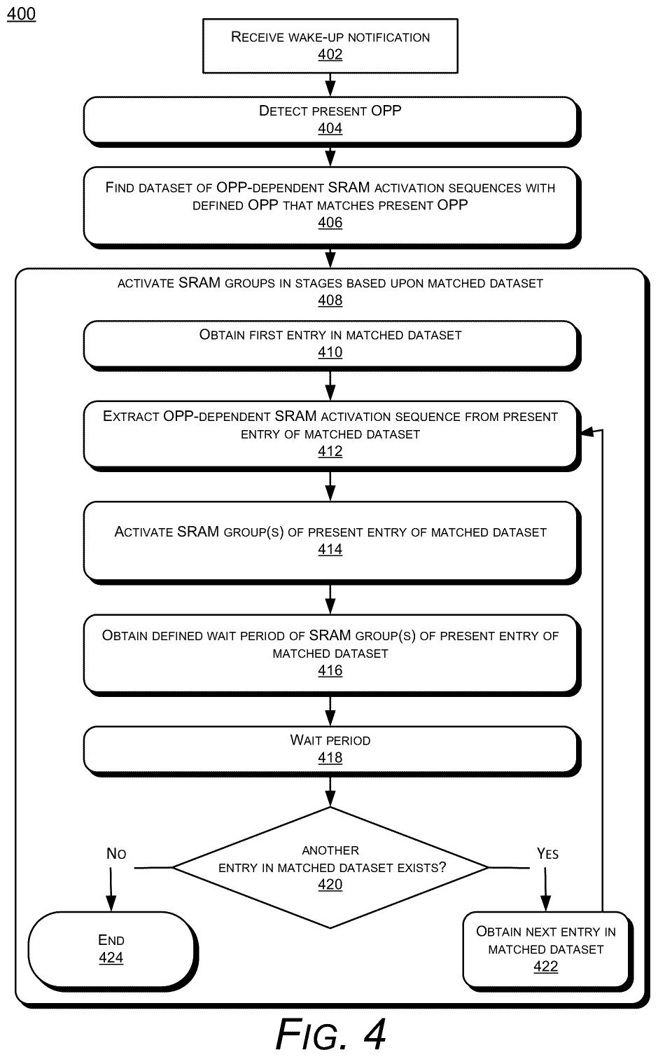

FIG. 4 illustrates an example method 400 for in-rush current surge preclusion on SRAM memory subsystems in accordance with one or more implementations described herein. In some instances, the example method 400 may be performed by a power management unit and/or OPP control and status registers (such as power management unit 202 and OPP control and status registers 210). For illustration purposes, the example method 400 is described herein as being performed by a power management unit.

At 402, a power management unit receives a wake-up notification from one or more wake-up sources.

At 404, the power management unit detects a present OPP of the integrated circuitry. In some implementations, the detection may include obtaining the present OPP from another component, such as the OPP control and status registers 210.

At 406, the power management unit searches for a dataset library to find a dataset of the OPP-dependent SRAM activation sequence with a defined OPP that matches the present OPP. Each dataset includes entries that provide the OPP-dependent SRAM activation sequence that specifies the activation of one or more groups of SRAMs in stages, the defined OPP, and the defined wait time for the activation of each specified group of SRAMs.

If no match is found, in some implementations, a close match is selected. If no dataset has a matching defined OPP, then method 400 ends with Error. If found, then the method 400 proceeds to the next operation at 408.

At 408, the power management unit activates (e.g., awakens) the SRAM groups in stages based on the information found in the matched dataset. In particular, that information includes the OPP-dependent SRAM activation sequence of the matched dataset. The following operations are part of operation 408.

At 410, the power management unit obtains the first entry in the matched dataset of the OPP-dependent SRAM activation sequences. This marks the beginning of the first stage of the SRAM activation.

At 412, the power management unit extracts the OPP-dependent SRAM activation sequence from the present entry of the matched dataset. During the first stage of the SRAM activation operation 408, the present entry is the first entry.

At 414, the power management unit activates one or more groups of SRAMs based on the OPP-dependent SRAM activation sequence of the present entry of the matched dataset. During the first stage, the first one or more groups of SRAMs are activated.

At 416, the power management unit obtains the defined wait period of the present entry in a matched dataset of the OPP-dependent SRAM activation sequences. During the first stage, the present entry is the first entry.

At 418, the power management unit waits for the defined wait period obtained at 416. During this time, the SRAM group activated at 414 is completing its activation.

At 420, the power management unit determines whether there is another entry in the matched dataset. If not, then the method 400 ends at 424. If there are more entries, then, at 422, the power management unit obtains the next entry in the matched dataset and the method returns to operation 412 to start the next stage. Operations 412-422 loop as long as there are more entries in the dataset and thus more SRAM groups to be activated.

### CONCLUSION

Although implementations of techniques for, and apparatuses enabling, OPP-aware in-rush current surge preclusion of memory systems of integrated circuitry have been described in language specific to features and/or methods, it is to be understood that the subject of the appended claims is not necessarily limited to the specific features or methods described. Rather, the specific features and methods are disclosed as example implementations enabling technology for OPP-aware in-rush current surge preclusion of memory systems of integrated circuitry.

What is claimed is:

1. An integrated circuitry that facilitates preclusion of in-rush current surge of an awakening memory, the integrated circuitry comprising:
a power management unit coupled to one or more wake-up sources;
a dataset library coupled to the power management unit and configured to store multiple datasets of operating performance point (OPP)-dependent static random-access memory (SRAM) activation sequences; and
a memory subsystem coupled to the power management unit, the memory subsystem including SRAMs that are divided into multiple SRAM groups;
the power management controller being configured to:
receive a wake-up notification from the one or more wake-up sources;
detect a present OPP of the integrated circuitry;
based on the present OPP, select a dataset having a defined OPP that matches the present OPP; and
activate the SRAM groups in stages based on an OPP-dependent SRAM activation sequence of the matched dataset.

2. The integrated circuitry of claim 1, wherein each dataset of the OPP-dependent SRAM activation sequences is associated with the defined OPP.

3. The integrated circuitry of claim 1 further comprising the power management controller being configured to maintain each activation stage for a defined wait time before the next stage is activated.

4. The integrated circuitry of claim 1, wherein the matched dataset closely matches the present OPP.

5. The integrated circuitry of claim 1 further comprising an OPP control and status register (CSR) coupled to the power management unit, the OPP CSR being configured to determine the present OPP of the integrated circuitry.

6. The integrated circuitry of claim 1 further comprising an OPP control and status register (CSR) coupled to the power management unit, the OPP CSR being configured to store the present OPP of the integrated circuitry.

7. The integrated circuitry of claim 1, wherein each dataset includes entries that provide an OPP-dependent SRAM activation sequence that specifies the activation of one or more groups of SRAMs in stages, the defined OPP, and a defined wait time for the activation of each specified group of SRAMs.

8. The integrated circuitry of claim 7, wherein the activation of the SRAM groups in stages includes:
obtain an entry in the matched dataset of the OPP-dependent SRAM activation sequences;
obtain a defined wait time of the entry in the matched dataset of the OPP-dependent SRAM activation sequences;
activate one or more groups of SRAMs in stages based on an OPP-dependent SRAM activation sequence of the matched dataset; and
after the defined wait period associated with each activation stage of the one or more groups of SRAMs, repeat the above steps of this claim for each entry in the matched dataset of the OPP-dependent SRAM activation sequences.

9. The integrated circuitry of claim 1, wherein the present OPP includes voltage, frequency, or a combination thereof.
